(19) United States
(12) Patent Application Publication
(10) Pub. No.: US 2023/0394879 A1
(43) Pub. Date: Dec. 7, 2023

(54) INFORMATION PROCESSING APPARATUS, OPERATION METHOD OF INFORMATION PROCESSING APPARATUS, AND OPERATION PROGRAM OF INFORMATION PROCESSING APPARATUS

(71) Applicant: FUJIFILM Corporation, Tokyo (JP)

(72) Inventors: Yuto TANAKA, Saitama-shi (JP); Asuka YAMASHITA, Saitama-shi (JP); Masako YOSHIDA, Saitama-shi (JP); Toshihiko KAKU, Saitama-shi (JP); Masashi KURANOSHITA, Saitama-shi (JP)

(73) Assignee: FUJIFILM Corporation, Tokyo (JP)

(21) Appl. No.: 18/453,764

(22) Filed: Aug. 22, 2023

Related U.S. Application Data
(63) Continuation of application No. PCT/JP2022/003109, filed on Jan. 27, 2022.

(30) Foreign Application Priority Data
Mar. 24, 2021 (JP) 2021-050781

(51) Int. Cl. G06V 40/16; G06V 10/75; G06V 20/40

(52) U.S. Cl. CPC G06V 40/174; G06V 10/758; G06V 20/44

(57) ABSTRACT

A CPU of an information processing server includes an acquisition unit, a derivation unit, and a distribution control unit. The acquisition unit acquires an image captured by a user during a target event for which a satisfaction level of the user is measured. The derivation unit derives the satisfaction level of the user with the target event based on the image. The distribution control unit presents an attribute of the user and satisfaction level-related information which is related to the satisfaction level to an organizer of the target event.

### CROSS-REFERENCE TO RELATED APPLICATIONS

This application is a continuation application of International Application No. PCT/JP2022/003109 filed on Jan. 27, 2022, the disclosure of which is incorporated herein by reference in its entirety. Further, this application claims priority from Japanese Patent Application No. 2021-050781 filed on Mar. 24, 2021, the disclosure of which is incorporated herein by reference in its entirety.

### BACKGROUND

### 1. Technical Field

The technology of the present disclosure relates to an information processing apparatus, an operation method of an information processing apparatus, and an operation program of an information processing apparatus.

### 2. Description of the Related Art

Information suitable for a user is presented to the user. For example, JP2012-190244A describes the technology of acquiring an image captured by a user at a tourist spot, deriving a satisfaction level of the user with the tourist spot based on the number of images, and presenting a recommended tourist spot according to the derived satisfaction level to the user.

### SUMMARY

Among organizers of various events, such as a tour around the tourist spots or outdoor experiences, such as trekking, camping, fishing, sweet potato digging, and rice planting, there is an organizer who performs marketing to increase the number of users who participate in the event. For such an organizer who performs marketing, information, such as what is an attribute of the user who has a high satisfaction level, is extremely important.

Here, as the related-art method of knowing the satisfaction level of the user with the event, there is a method of sending a questionnaire to the user and requesting the user to answer the questionnaire. However, in this related-art method, it takes time and effort to send and collect the questionnaire, and it takes time and effort to answer the questionnaire. In that respect, the technology described in JP2012-190244A of deriving the satisfaction level from the image captured by the user at the tourist spot is suitable because it does not take time and effort to send and collect the questionnaire, and to answer the questionnaire. However, even in a case in which the satisfaction level of the user derived as in JP2012-190244A is presented to the organizer of the event as it is, the satisfaction level is not very useful for the organizer of the event.

An embodiment according to the technology of the present disclosure provides an information processing apparatus, an operation method of an information processing apparatus, and an operation program of an information processing apparatus capable of presenting information useful for event marketing to an organizer of an event without taking time and effort.

The present disclosure relates to an information processing apparatus comprising a processor, and a memory connected to or built in the processor, in which the processor acquires an image captured by a user during a target event for which a satisfaction level of the user is measured, derives the satisfaction level of the user with the target event based on the image, and presents an attribute of the user and satisfaction level-related information which is related to the satisfaction level to an organizer of the target event.

It is preferable that the processor derives a specific attribute, which is an attribute of a user who tends to prefer the target event among the users who participate in the target event, by statistically analyzing the satisfaction level, and presents the specific attribute as the satisfaction level-related information.

It is preferable that the processor performs heavier weighting in a case of deriving the specific attribute on an attribute of the user having a higher satisfaction level.

It is preferable that the processor presents, in addition to the specific attribute, a set attribute, which is an attribute of the user set by the organizer in the target event, as the satisfaction level-related information.

It is preferable that the processor derives a first representative satisfaction level, which represents the satisfaction levels of all the users who participate in the target event, and a second representative satisfaction level, which represents the satisfaction level of a user having a set attribute set by the organizer in the target event among the users who participate in the target event, and presents a notification prompting to change the set attribute to the organizer in a case in which the second representative satisfaction level is lower than the first representative satisfaction level, and an absolute value of a difference between the first representative satisfaction level and the second representative satisfaction level satisfies a threshold value condition set in advance.

It is preferable that the processor presents information in which the satisfaction level and the attribute of the user are associated with each other, as the satisfaction level-related information.

It is preferable that the processor derives the satisfaction level based on a condition related to an image-related evaluation value, which is at least any one of the number of the captured images, the number of times of reproduction of the image, or the number of posts of the image.

It is preferable that the processor derives the satisfaction level based on an analysis result of an expression of a person appearing in the image.

It is preferable that the processor derives the satisfaction level for at least any one of an imaging location or an imaging time slot of the image in the target event.

The present disclosure relates to an operation method of an information processing apparatus, the method comprising acquiring an image captured by a user during a target event for which a satisfaction level of the user is measured, deriving the satisfaction level of the user with the target event based on the image, and presenting an attribute of the user and satisfaction level-related information which is related to the satisfaction level to an organizer of the target event.

The present disclosure relates to an operation program of an information processing apparatus, the program causing a computer to execute a process comprising acquiring an image captured by a user during a target event for which a satisfaction level of the user is measured, deriving the satisfaction level of the user with the target event based on the image, and presenting an attribute of the user and satisfaction level-related information which is related to the satisfaction level to an organizer of the target event.

According to the technology of the present disclosure, it is possible to provide the information processing apparatus, the operation method of the information processing apparatus, and the operation program of the information processing apparatus capable of presenting the information useful for event marketing to the organizer of the event without taking time and effort.

### BRIEF DESCRIPTION OF THE DRAWINGS

Exemplary embodiments according to the technique of the present disclosure will be described in detail based on the following figures, wherein:

FIG. 1 is a diagram showing an information processing system;

FIG. 2 is a diagram showing information exchanged between an information processing server, a user terminal, and an organizer terminal;

FIG. 3 is a diagram showing an inside of an event information DB and a content of event information;

FIG. 4 is a diagram showing an inside of an image DB;

FIG. 5 is a diagram showing a state in which an event ID is added to accessory information of an image captured by a user during an event;

FIG. 6 is a block diagram showing a computer that constitutes the information processing server and the organizer terminal;

FIG. 7 is a block diagram showing a processing unit of a CPU of the information processing server;

FIG. 8 is a diagram showing a satisfaction level-related information distribution request;

FIG. 9 is a flowchart showing a procedure of derivation of satisfaction level-related information by a derivation unit;

FIG. 10 is a diagram showing a state in which the number of captured images is converted into a satisfaction level by using a satisfaction level conversion table;

FIG. 11 is a diagram showing a state in which a mean satisfaction level is calculated for each attribute of the user, and a specific attribute, which is an attribute of a user who tends to prefer a target event among the users who participate in the target event, is derived based on the mean satisfaction level;

FIG. 12 is a block diagram showing a processing unit of a CPU of the organizer terminal;

FIG. 13 is a diagram showing an information display screen for displaying the specific attribute;

FIG. 14 is a flowchart showing a procedure of processing of the information processing server;

FIG. 15 is a diagram showing a state in which the number of times of reproduction of the image is converted into the satisfaction level by using the satisfaction level conversion table;

FIG. 16 is a diagram showing a state in which the number of posts of the image is converted into the satisfaction level by using the satisfaction level conversion table;

FIG. 17 is a diagram showing an aspect in which heavier weighting in a case of deriving the specific attribute is performed on the attribute of the user having a higher satisfaction level;

FIG. 18 is a diagram showing a set attribute table;

FIG. 19 is a diagram showing the satisfaction level-related information including the specific attribute and a set attribute;

FIG. 20 is a diagram showing an information display screen for displaying the specific attribute and the set attribute;

FIG. 21 is a diagram showing an outline of processing according to a 2_2nd embodiment of presenting a notification prompting to change the set attribute to the organizer;

FIG. 22 is a diagram showing an information display screen for displaying a message prompting the organizer to change the set attribute;

FIG. 23 is a diagram showing the satisfaction level-related information in which the satisfaction level and the attribute of the user are associated with each other;

FIG. 24 is a diagram showing a state in which an expression of a person appearing in the image is analyzed by an analysis unit, and an expression analysis result is output from the analysis unit to the derivation unit;

FIG. 25 is a diagram showing a state in which the satisfaction level derived from the number of the captured images is added or subtracted based on the number of images in which the expression analysis result is a smile and a satisfaction level addition/subtraction condition;

FIG. 26 is a diagram showing an outline of processing of a 4_1st embodiment of deriving the satisfaction level for each imaging location of the image in the target event;

FIG. 27 is a diagram showing an outline of processing of a 4_2nd embodiment of deriving the satisfaction level for each imaging time slot of the image in the target event;

FIG. 28 is a diagram showing user movement route information;

FIG. 29 is a diagram showing user gathering/scatter information; and

FIG. 30 is a diagram showing an outline of processing of deriving trend information, and the trend information.

### DETAILED DESCRIPTION

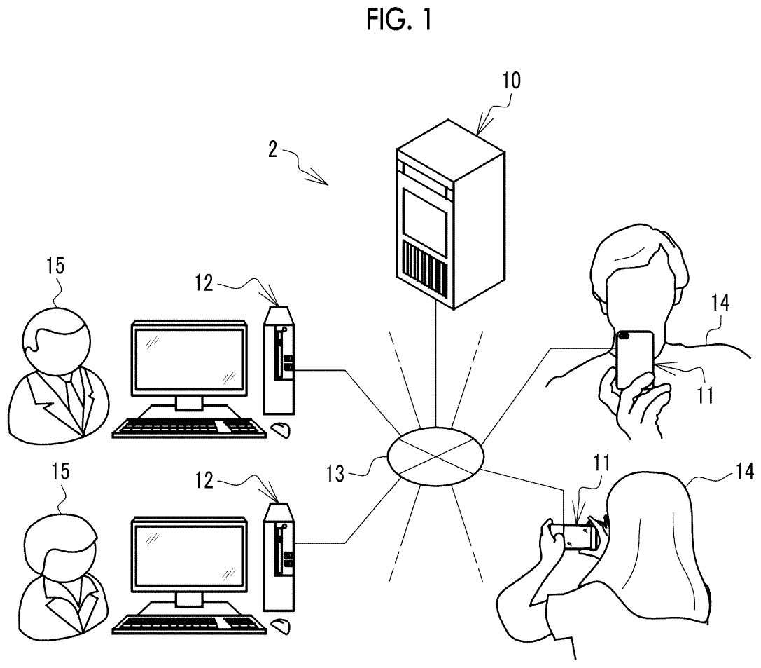

As an example, as shown in FIG. 1, an information processing system 2 comprises an information processing server 10, a plurality of user terminals 11, and a plurality of organizer terminals 12. The information processing server 10, the user terminal 11, and the organizer terminal 12 are connected to each other via a network 13 to be able to communicate with each other. The network 13 is a wide area network (WAN) of, for example, the Internet or a public communication network.

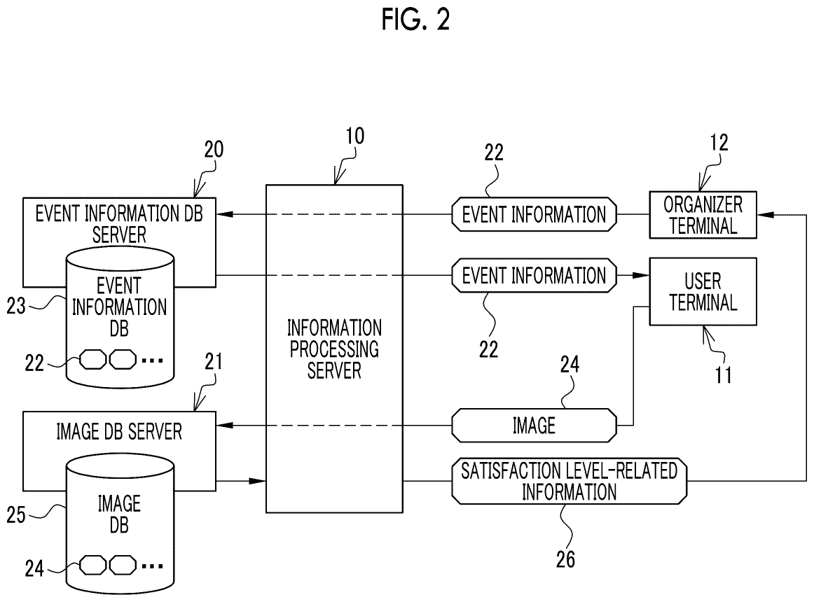

The information processing server 10 is, for example, a server computer, a workstation, or the like, and is an example of an “information processing apparatus” according to the technology of the present disclosure. The user terminal 11 is a terminal possessed by each user 14. The user terminal 11 has at least a function of reproducing and displaying an image 24 (see FIG. 2 and the like) and a function of transmitting the image 24 to the information processing server 10. The user terminal 11 is, for example, a smartphone, a tablet terminal, a personal computer, and the like.

The organizer terminal 12 is a terminal operated by an organizer 15 of an event. The organizer terminal 12 is, for example, a desktop personal computer. The event includes, for example, a tour around the tourist spots, a tour to play in a theme park, a farming experience, a craft experience, a lifelong learning experience, a stamp rally, and the like. The organizer is, for example, an employee or a staff of a travel company, an event planning company, a local public body, and the like.

As an example, as shown in FIG. 2, the information processing server 10 is connected with an event information database (hereinafter, abbreviated as DB) server 20 and an image DB server 21 via a network (not shown), such as a local area network (LAN). The information processing server 10 receives event information 22 input by the organizer 15 of the event through the organizer terminal 12 from the organizer terminal 12. The received event information 22 is transmitted to the event information DB server 20. The event information DB server 20 includes an event information DB 23. The event information DB server 20 accumulates the event information 22 from the information processing server 10 in the event information DB 23, and manages the event information 22.

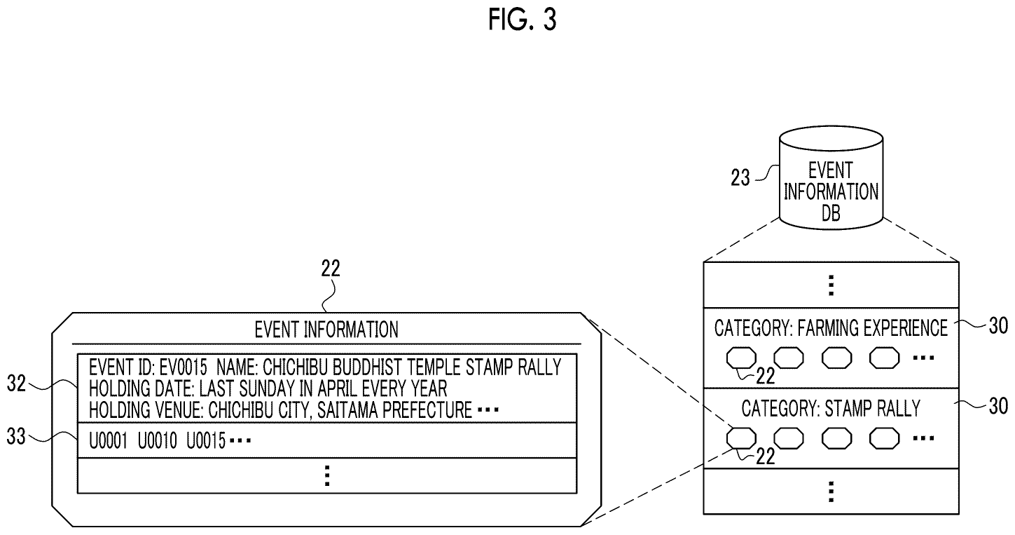

The information processing server 10 receives a search request (not shown) for the event information 22 from the user terminal 11, and transmits the search request to the event information DB server 20. The search request for the event information 22 includes a search keyword for the event desired by the user 14. The search keyword is, for example, a category 30 (see FIG. 3) of each event, a holding date, a holding venue, and the like. The event information DB server 20 searches the event information DB 23 for the event information 22 according to the transmitted search request, and transmits the searched event information 22 to the information processing server 10. The information processing server distributes the event information 22 from the event information DB server 20 to the user terminal 11 that is a transmission source of the search request.

The user 14 views the event information 22 distributed from the information processing server 10 through the user terminal 11. The user 14 operates the user terminal 11 to select the event information 22 of the event that the user 14 wants to participate in from the event information 22 distributed from the information processing server 10. Then, the user 14 applies for participation in the event of the selected event information 22.

The information processing server 10 receives the image 24 from the user terminal 11, and transmits the received image 24 to the image DB server 21. The image DB server 21 includes an image DB 25. The image DB server 21 accumulates the image 24 from the information processing server 10 in the image DB 25, and manages the image 24. In addition, the image DB server 21 transmits the image 24 accumulated in the image DB 25 to the information processing server 10 according to a request from the information processing server 10.

In addition, the information processing server 10 distributes satisfaction level-related information 26 to the organizer terminal 12. The satisfaction level-related information 26, which will be described in detail below, is information related to an attribute of the user 14 and a satisfaction level of the user 14 with a target event.

As shown in FIG. 3 as an example, the event information DB 23 is divided into a plurality of categories 30, and a plurality of pieces of event information 22 is stored in each category 30. The category 30 is a major classification of events, such as “farming experience” and “stamp rally”. In addition to these, the category 30 includes the “tour around tourist spots”, the “tour to play at a theme park”, the “craft experience”, and the “lifelong learning experience”.

The event information 22 includes basic information 32, application user information 33, and the like. The basic information 32 includes event identification data (ID), a name, a holding date, a holding venue, and the like for uniquely identifying the event. The event ID is automatically assigned by the event information DB server 20 in a case in which the event information 22 is first stored in the event information DB 23. In the application user information 33, the user ID of the user 14 who applies for participation in the event through the user terminal 11, such as “U0001” or “U0010”, is registered.

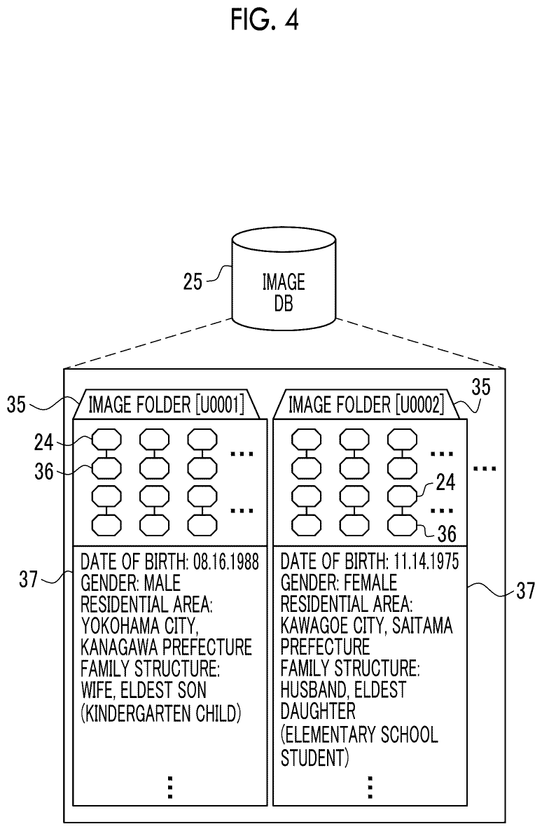

As shown in FIG. 4 as an example, the image DB 25 is provided with a plurality of image folders 35. The image folder 35 is a folder allocated to each user 14 one by one, and is a folder unique to one user 14. Therefore, the image folders 35 are provided for the number of the users 14. The user ID is associated with the image folder 35.

The image 24 possessed by the user 14 is stored in the image folder 35. The image 24 possessed by the user 14 includes an image captured by the user 14 using a camera function of the user terminal 11. In addition, the image 24 possessed by the user 14 also includes an image captured by a digital camera other than the user terminal 11. Further, the image 24 possessed by the user 14 also includes an image received by the user 14 from another user 14, such as a friend or a family member, an image downloaded by the user 14 on the Internet site, an image read by the user 14 with a scanner, and the like. The image 24 in the image folder 35 is periodically synchronized with the image 24 locally stored in the user terminal 11.

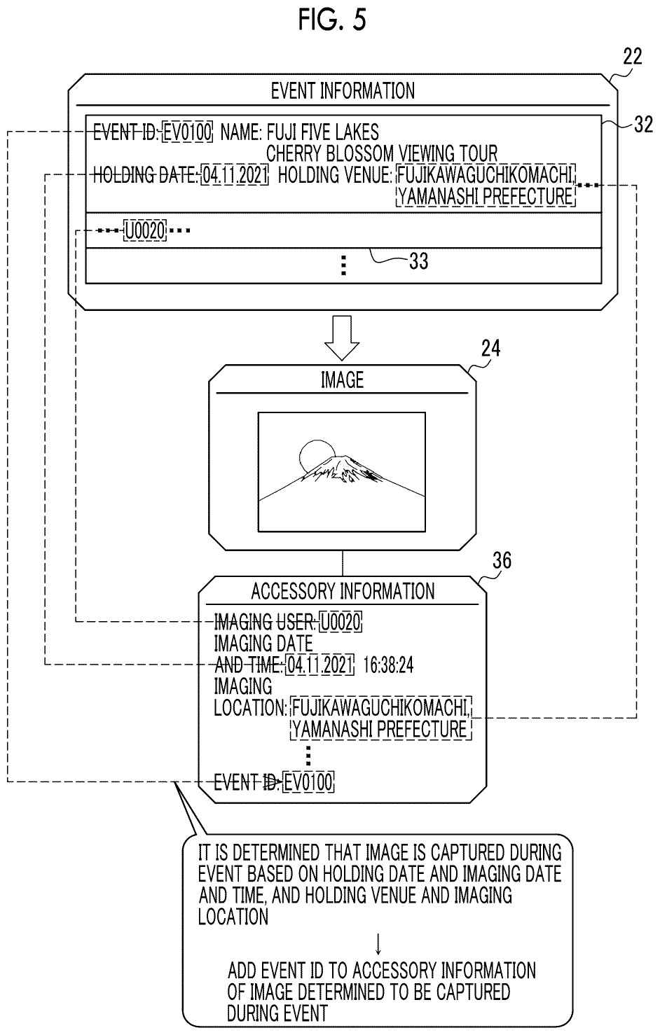

Each image 24 includes accessory information 36. The user ID of the user 14 who captures the image 24, the imaging date and time of the image 24, an imaging location, and the like are registered in the accessory information 36 (see FIG. 5). The imaging location is a location known from longitude and latitude information obtained by a global positioning system (GPS) function built in the user terminal 11 or the digital camera.

Attribute information 37 of the user 14 is associated with the image folder 35. The attribute information 37 is registered by the user 14. The attribute information 37 includes a date of birth, a gender, a residential area, a family structure, or the like of the user 14. The residential area is a combination of prefecture, city, ward, town, and village. In the family structure, the types of children, such as a kindergarten child and an elementary school student, are registered. It should be noted that the attribute information 37 may be stored in a DB different from the image DB 25.

The user 14 participates in the event that he/she applies for. Then, the image 24 is captured by using the camera function of the user terminal 11 during the event. FIG. 5 shows an example of the image 24 captured by the user 14 during the event.

In FIG. 5, the information processing server 10 first inquires to the event information DB server 20 as to whether or not there is the event information 22 in which the user ID of the user 14 (referred to as an imaging user in FIG. 5) who captures the image 24 is registered in the application user information 33. In a case in which there is the event information 22 in which the user ID of the user 14 who captures the image 24 is registered in the application user information 33, the information processing server 10 collates the holding date of the event with imaging date and time of the image 24, and the holding venue of the event with the imaging location of the image 24. In a case in which the holding date and the imaging date and time, and the holding venue and the imaging location match, the information processing server 10 determines that the image 24 is captured by the user 14 during the event. The information processing server 10 adds the event ID of the event to the accessory information 36 of the image 24 that is determined to be captured by the user 14 during the event. Therefore, it is possible to distinguish whether or not the image is the image 24 captured by the user 14 during the event, depending on whether or not the event ID is registered in the accessory information 36. It should be noted that the user 14 may manually input the fact that the image 24 is captured during the event, such as registering the name of the event in a tag of the accessory information 36.

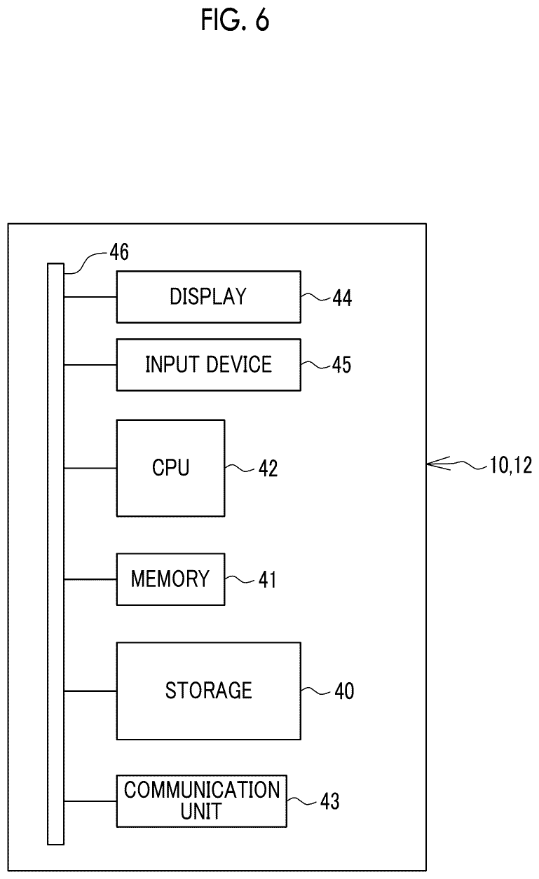

As shown in FIG. 6 as an example, the computers constituting the information processing server 10 and the organizer terminal 12 basically have the same configuration, and comprise a storage 40, a memory 41, a central processing unit (CPU) 42, a communication unit 43, a display 44, and an input device 45. These units are connected to each other via a busline 46.

The storage 40 is a hard disk drive that is built in the computers constituting the information processing server 10 and the organizer terminal 12 or connected thereto through a cable or a network. Alternatively, the storage 40 is a disk array in which a plurality of hard disk drives are mounted. A control program, such as an operating system, various application programs (hereinafter, abbreviated as AP), various data associated with these programs, and the like are stored in the storage 40. It should be noted that a solid state drive may be used instead of the hard disk drive.

The memory 41 is a work memory for the CPU 42 to execute processing. The CPU 42 loads the program stored in the storage 40 into the memory 41, and executes processing according to the program. Accordingly, the CPU 42 integrally controls the respective units of the computer. The CPU 42 is an example of a “processor” according to the technology of the present disclosure. It should be noted that the memory 41 may be built in the CPU 42.

The communication unit 43 is a network interface that performs control of transmitting various types of information via the network 13 and the like. The display 44 displays various screens. Various screens are provided with an operation function by a graphical user interface (GUI). The computers constituting the information processing server 10 and the organizer terminal 12 receive input of an operation instruction from the input device 45 through various screens. The input device 45 is a keyboard, a mouse, a touch panel, and the like.

It should be noted that, in the following description, a subscript “A” is assigned to a reference numeral of each unit of the computer constituting the information processing server 10 and a subscript “B” is assigned to a reference numeral of each unit of the computer constituting the organizer terminal 12, for distinction.

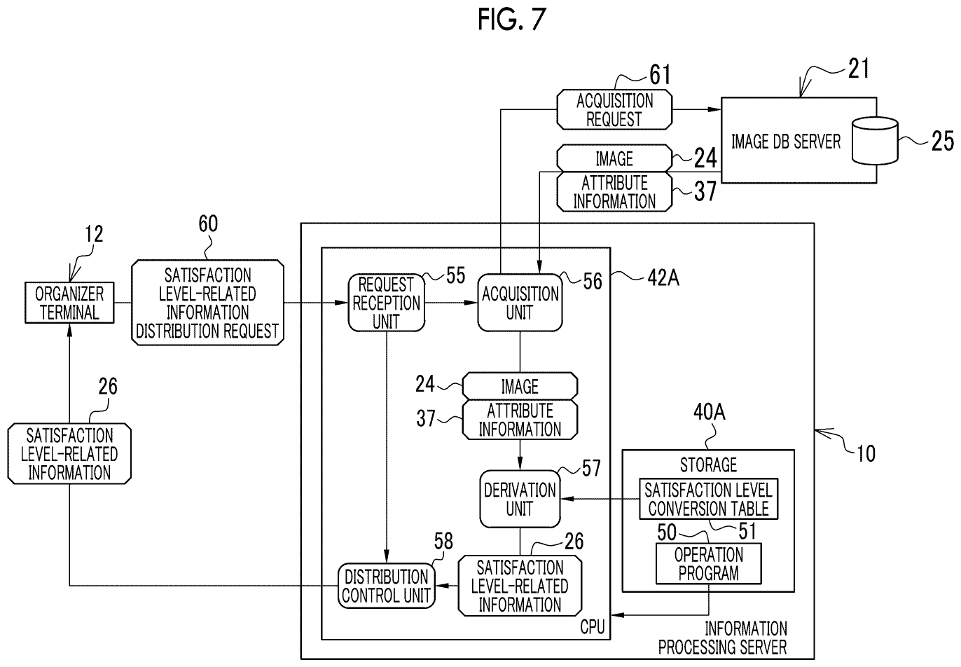

For example, as shown in FIG. 7, an operation program 50 is stored in a storage 40A of the information processing server 10. The operation program 50 is an AP for causing the computer constituting the information processing server 10 to function as an “information processing apparatus” according to the technology of the present disclosure. In other words, the operation program 50 is an example of an “operation program of an information processing apparatus” according to the technology of the present disclosure. A satisfaction level conversion table 51 is also stored in the storage 40A.

In a case in which the operation program 50 is started up, a CPU 42A of the information processing server 10 functions as a request reception unit 55, an acquisition unit 56, a derivation unit 57, and a distribution control unit 58 in cooperation with the memory 41 and the like.

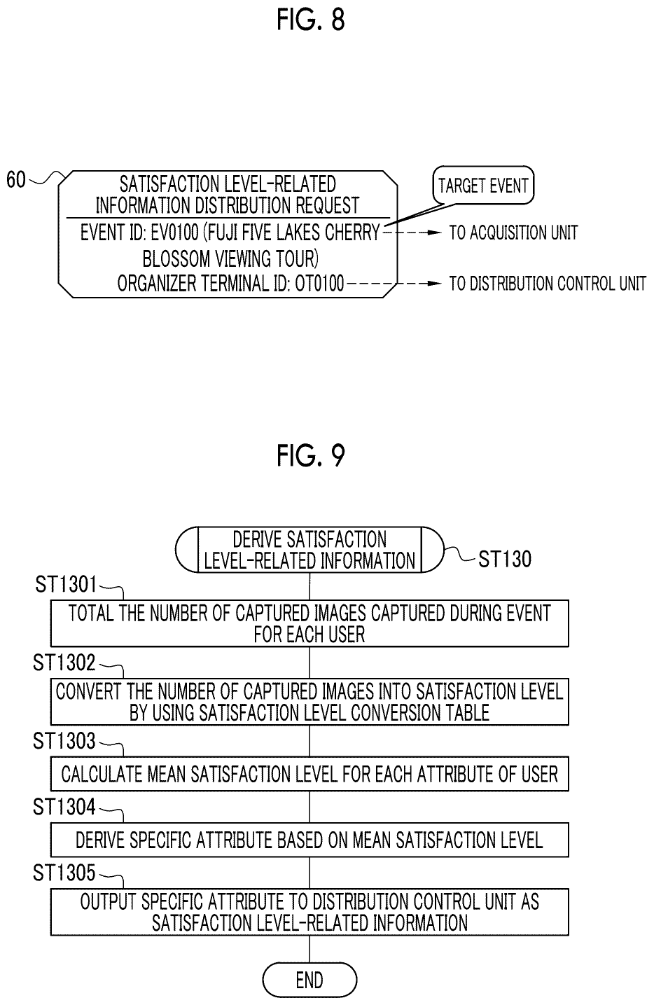

The request reception unit 55 receives various requests from the organizer terminal 12. For example, the request reception unit 55 receives a satisfaction level-related information distribution request 60. As shown in FIG. 8 as an example, the satisfaction level-related information distribution request 60 includes the event ID and an organizer terminal ID. The event ID is an ID of the event for which the organizer 15 wants to measure the satisfaction level of the user 14, that is, the “target event” according to the technology of the present disclosure. The organizer terminal ID is an ID of the organizer terminal 12 that transmits the satisfaction level-related information distribution request 60. The request reception unit 55 outputs the event ID in the satisfaction level-related information distribution request 60 to the acquisition unit 56. In addition, the request reception unit 55 outputs the organizer terminal ID in the satisfaction level-related information distribution request 60 to the distribution control unit 58.

Returning to FIG. 7, in a case in which the event ID of the target event is input from the request reception unit 55, the acquisition unit 56 transmits an acquisition request 61 to the image DB server 21. The acquisition request 61 is a copy of the event ID of the target event, and is a content of requesting the image 24 in which the event ID of the target event is registered in the accessory information 36. The image 24 in which the event ID of the target event is registered in the accessory information 36 is nothing but the image 24 captured by the user 14 during the target event. In addition, the acquisition request 61 is a content of requesting the attribute information 37 of the user 14 who captures the image 24 in which the event ID of the target event is registered in the accessory information 36.

The image DB server 21 reads out the image 24 and the attribute information 37 according to the acquisition request 61 from the image DB 25, and transmits the read out image 24 and attribute information 37 to the information processing server 10. The acquisition unit 56 acquires the image 24 and the attribute information 37 transmitted from the image DB server 21 according to the acquisition request 61. The acquisition unit 56 outputs the acquired image 24 and the attribute information 37 to the derivation unit 57. The derivation unit 57 derives the satisfaction level of the user 14 with the target event based on the image 24 from the acquisition unit 56 while referring to the satisfaction level conversion table 51. The derivation unit 57 generates the attribute information 37 from the acquisition unit 56 and the satisfaction level-related information 26 based on the derived satisfaction level. The derivation unit 57 outputs the generated satisfaction level-related information 26 to the distribution control unit 58.

The distribution control unit 58 performs control of distributing the satisfaction level-related information 26 from the derivation unit 57 to the organizer terminal 12 that is a transmission source of the satisfaction level-related information distribution request 60. In this case, the distribution control unit 58 specifies the organizer terminal 12 that is the transmission source of the satisfaction level-related information distribution request 60 based on the organizer terminal ID in the satisfaction level-related information distribution request from the request reception unit 55. In the present example, the satisfaction level-related information 26 is presented to the organizer 15 by distributing the satisfaction level-related information 26 to the organizer terminal 12.

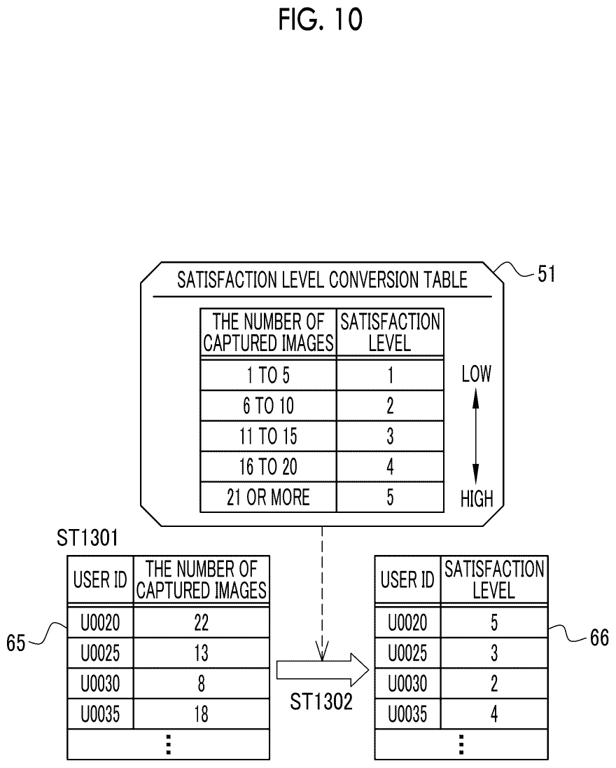

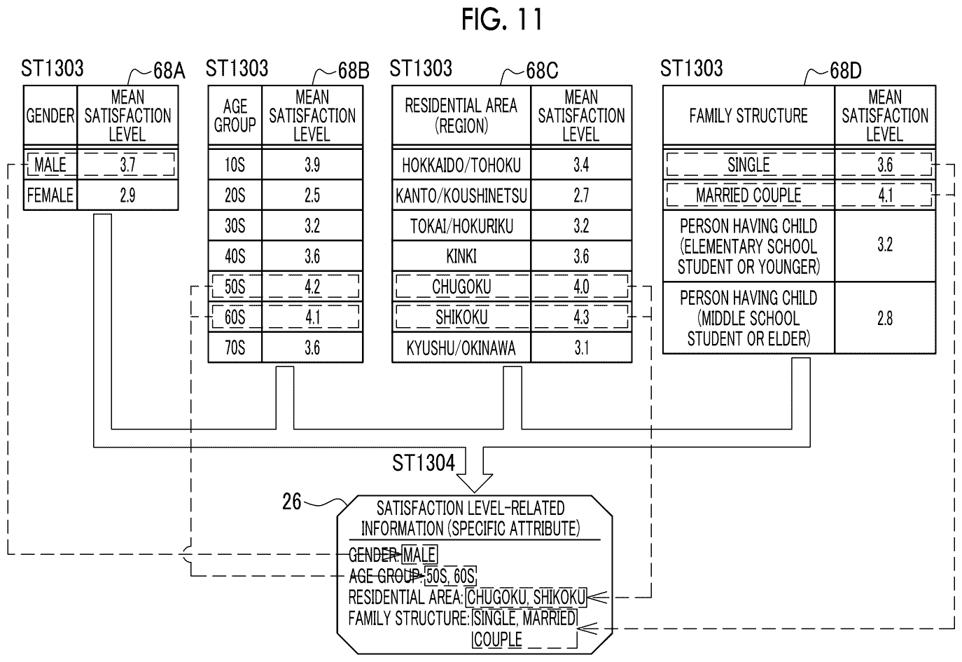

FIG. 9 is a flowchart showing an example of a procedure of the derivation of the satisfaction level-related information 26 by the derivation unit 57. In addition, FIG. 10 and FIG. 11 are explanatory diagrams showing examples of the procedure of the derivation of the satisfaction level-related information 26 by the derivation unit 57.

First, as shown in a table 65 of FIG. 10, the derivation unit 57 totals the number of the captured images 24 captured during the target event for each user 14 (step ST1301). As shown in a table 66, the derivation unit 57 converts the totaled number of the captured images into the satisfaction level by using the satisfaction level conversion table 51 (step ST1302). It should be noted that the number of the captured images is an example of an “image-related evaluation value” according to the technology of the present disclosure.

The satisfaction level conversion table 51 is a table in which the satisfaction level with the number of the captured images 24 captured during the target event is registered. In FIG. 10, a satisfaction level of 1 for the number of the captured images of 1 to 5, a satisfaction level of 2 for the number of the captured images of 6 to 10, . . . , a satisfaction level of 4 for the number of the captured images of 16 to 20, and a satisfaction level 5 for the number of the captured images of 21 or more are registered, respectively. The satisfaction level indicates that the user 14 is more satisfied with the target event as the numerical value is higher. The setting of the satisfaction level higher as the number of the captured images is larger in this way is based on the estimation that the user 14 who is satisfied with the target event captures more images 24. It should be noted that the satisfaction level conversion table 51 is an example of a “condition related to an image-related evaluation value” according to the technology of the present disclosure.

Next, the derivation unit 57 calculates a mean satisfaction level for each attribute of the user 14 as shown in tables 68A, 68B, 68C, and 68D of FIG. 11 (step ST1303). Specifically, as shown in the table 68A, the derivation unit 57 calculates the mean satisfaction level for each gender of the user 14. In addition, as shown in the table 68B, the derivation unit 57 calculates the mean satisfaction level of the user 14 for each age group. The age group includes 10s, 30s, 60s, and the like. In addition, as shown in the table 68C, the derivation unit 57 calculates the mean satisfaction level for each residential area (region) of the user 14. The residential area includes Hokkaido/Tohoku, Tokai/Hokuriku, and Kyushu/Okinawa. Further, as shown in the table 68D, the derivation unit 57 calculates the mean satisfaction level for each family structure of the user 14. The family structure includes a single and a person having a child (elementary school student or younger).

The derivation unit 57 derives a specific attribute, which is the attribute of the user 14 who tends to prefer the target event among the users 14 who participate in the target event, based on the calculated mean satisfaction level (step ST1304). Specifically, as shown in FIG. 11, the derivation unit 57 derives the gender having a relatively high mean satisfaction level as the specific attribute. In addition, the derivation unit 57 derives the age group having the highest and second highest mean satisfaction levels, the residential area having the highest and second highest mean satisfaction levels, and the family structure having the highest and second highest mean satisfaction levels, as the specific attributes. FIG. 11 shows an example in which a male as the gender, 50s and 60s as the age group, Shikoku and Chugoku as the residential area, and the single and a married couple as the family structure are derived as the specific attributes. The derivation unit 57 outputs the derived specific attribute as the satisfaction level-related information 26 to the distribution control unit 58 (step ST1305).

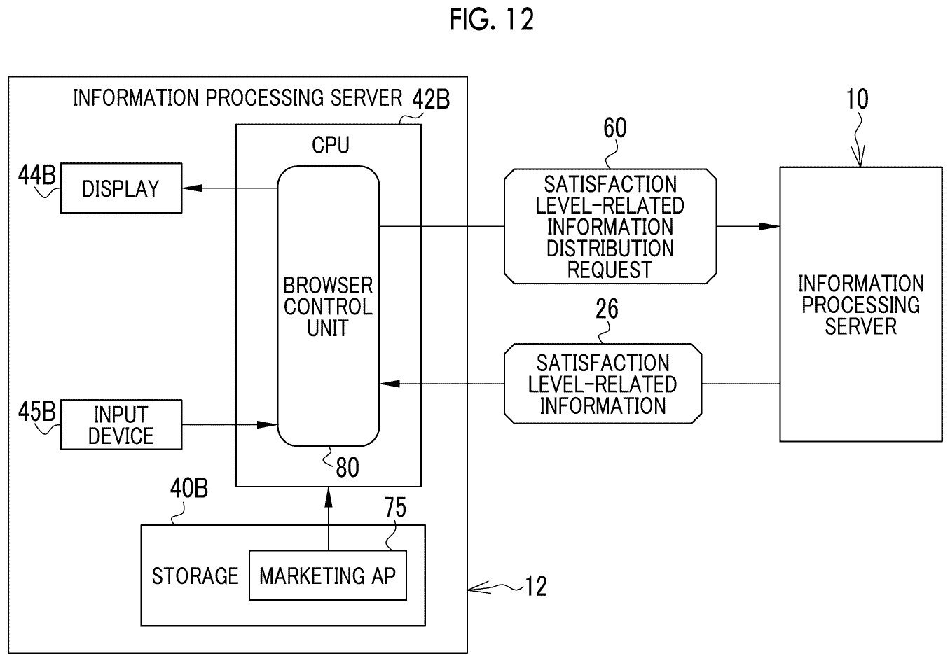

As shown in FIG. 12 as an example, a marketing AP 75 is stored in a storage 40B of the organizer terminal 12. A CPU 42B of the organizer terminal 12 functions as a browser control unit 80 in cooperation with the memory 41 and the like. The browser control unit 80 controls an operation of a web browser dedicated to the marketing AP 75.

The browser control unit 80 receives various operation instructions input from an input device 45B by the organizer 15 through various screens. The browser control unit 80 transmits various requests according to the operation instructions to the information processing server 10. For example, the browser control unit 80 transmits the satisfaction level-related information distribution request 60 to the information processing server 10 according to an instruction to distribute the satisfaction level-related information 26.

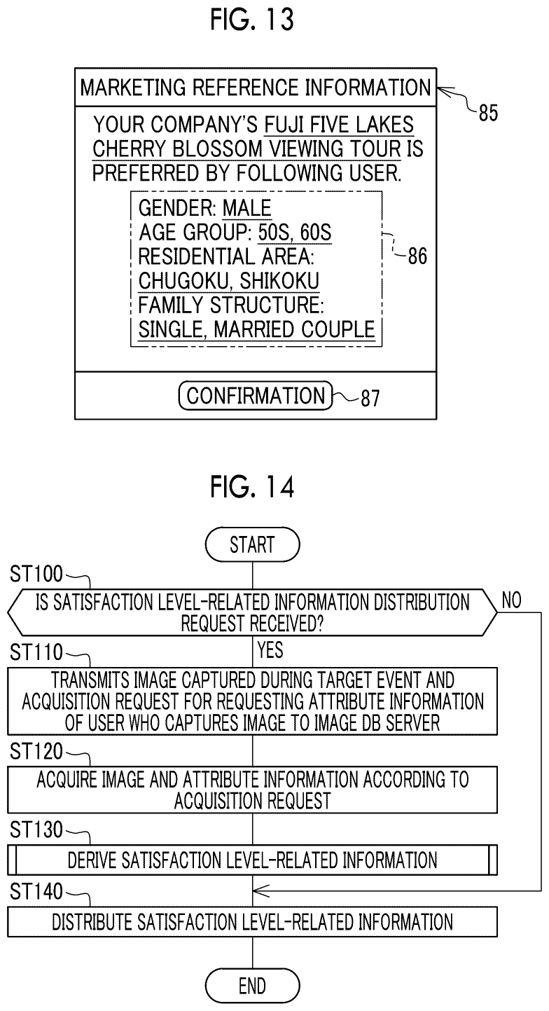

The browser control unit 80 generates various screens, such as an information display screen 85 (see FIG. 13), based on the satisfaction level-related information 26 from the information processing server 10. The browser control unit 80 displays and outputs various generated screens on a display 44B.

FIG. 13 shows an example of the information display screen 85 that is displayed and output on the display 44B of the organizer terminal 12. On the information display screen the name of the target event for which the distribution of the satisfaction level-related information 26 is requested is displayed. In addition, as indicated by a two-dot chain line enclosure and a reference numeral 86, the specific attributes as the satisfaction level-related information 26 are displayed on the information display screen 85. In FIG. 13, “Fuji five lakes cherry blossom viewing tour” is shown as the target event. In addition, as the specific attributes, as in the example shown in FIG. 11, the male, 50s and 60s, Shikoku and Chugoku, and the single and the married couple are shown. The display of the information display screen 85 is turned off in a case in which a confirmation button 87 is selected.

Next, an action with the configuration described above will be described with reference to the flowchart shown in FIG. 14 as an example. As shown in FIG. 7, the CPU 42A of the information processing server 10 functions as the request reception unit 55, the acquisition unit 56, the derivation unit 57, and the distribution control unit 58. Also, as shown in FIG. 12, the CPU 42B of the organizer terminal 12 functions as the browser control unit 80.

The organizer 15 issues the instruction to distribute the satisfaction level-related information 26 related to the event for which the satisfaction level of the user 14 is to be measured, that is, the target event through the input device 45B of the organizer terminal 12. As a result, the satisfaction level-related information distribution request 60 is transmitted from the browser control unit 80 to the information processing server 10.

The satisfaction level-related information distribution request 60 from the organizer terminal 12 is received by the request reception unit 55 of the information processing server (YES in step ST100). As shown in FIG. 8, the event ID of the target event in the satisfaction level-related information distribution request 60 is output from the request reception unit 55 to the acquisition unit 56. In addition, the organizer terminal ID in the satisfaction level-related information distribution request 60 is output from the request reception unit 55 to the distribution control unit 58.

The acquisition unit 56 transmits the image 24 captured by the user 14 during the target event and the acquisition request 61 for requesting the attribute information 37 of the user 14 who captures the image to the image DB server 21 (step ST110). The image DB server 21 reads out the image 24 and the attribute information 37 according to the acquisition request 61 from the image DB 25, and transmits the image 24 and the attribute information 37 to the information processing server 10. The image 24 and the attribute information 37 according to the acquisition request 61 are acquired by the acquisition unit 56 (step ST120).

As shown in FIGS. 9 to 11, the derivation unit 57 derives the satisfaction level of the user 14 with the target event based on the image 24. Then, the attribute information 37 and the satisfaction level-related information 26 based on the satisfaction level are derived (step ST130). The satisfaction level-related information 26 in the present example is the specific attribute that is the attribute of the user 14 who tends to prefer the target event among the users 14 who participate in the target event. The satisfaction level-related information 26 is output from the derivation unit 57 to the distribution control unit 58. The satisfaction level-related information 26 is distributed by the distribution control unit 58 to the organizer terminal 12 that is the transmission source of the satisfaction level-related information distribution request 60 (step ST140).

In the organizer terminal 12, the information display screen 85 shown in FIG. 13 is displayed and output on the display 44B by the browser control unit 80. As a result, the satisfaction level-related information 26 is provided for viewing by the organizer 15.

As described above, the CPU 42A of the information processing server 10 comprises the acquisition unit 56, the derivation unit 57, and the distribution control unit 58. The acquisition unit 56 acquires the image 24 captured by the user 14 during the target event for which the satisfaction level of the user 14 is measured. The derivation unit 57 derives the satisfaction level of the user 14 with the target event based on the image 24. The distribution control unit 58 presents the satisfaction level-related information 26 to the organizer 15 of the target event by distributing the attribute of the user 14 and the satisfaction level-related information 26 related to the satisfaction level to the organizer terminal 12 of the organizer 15 of the target event. Therefore, it is possible to present information useful for marketing the event to the organizer 15 of the event without taking time and effort. Therefore, it is possible for the organizer 15 to recommend the event to the user 14 under an appropriate marketing strategy. It is also suitable for the user 14 because there is a high possibility that an event suitable for his/her own attribute is recommended.

The derivation unit 57 derives a specific attribute, which is the attribute of the user 14 who tends to prefer the target event among the users 14 who participate in the target event, by statistically analyzing the satisfaction level. The distribution control unit 58 presents the specific attribute as the satisfaction level-related information 26. Therefore, the organizer 15 can know what kind of the user 14 should be a main target of the target event. The organizer 15 can take effective measures for increasing the number of the users 14 who participate in the target event, such as setting a content of the commercial of the target event to a content for the user 14 having the specific attribute, or narrowing down the user 14 to which the commercial of the target event is provided to the user 14 having the specific attribute.

The derivation unit 57 derives the satisfaction level based on the satisfaction level conversion table 51, which is a condition related to the number of the captured images 24. For this reason, the satisfaction level can be derived by relatively simple processing of totaling the number of the captured images 24 for each user 14 who participates in the target event, and converting the totaled number of the captured images into the satisfaction level by using the satisfaction level conversion table 51.

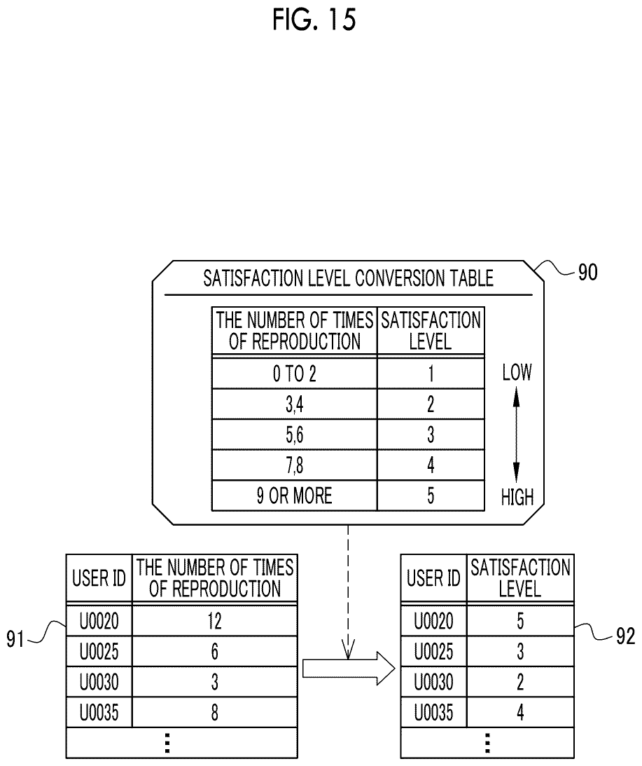

The image-related evaluation value is not limited to the number of the captured images 24 captured during the target event as shown as an example. As shown in FIG. 15 as an example, the number of times of reproduction of the image 24 captured during the target event may be adopted as the image-related evaluation value. In this case, the information processing server 10 receives the number of times the user 14 reproduces and displays the image 24 captured during the target event from a device, such as the user terminal 11, having the function of reproducing and displaying the image 24.

The derivation unit 57 uses a satisfaction level conversion table 90 in which the satisfaction level with the number of times of reproduction of the image 24 captured during the target event is registered. In FIG. 15, a satisfaction level 1 for the number of times of reproduction of 0 times to 2 times, a satisfaction level 2 for the number of times of reproduction of 3 times to 4 times, . . . , a satisfaction level 4 for the number of times of reproduction of 7 times to 8 times, and a satisfaction level 5 for the number of times of reproduction of 9 times or more are registered, respectively. The setting of the satisfaction level higher as the number of times of reproduction is larger in this way is based on the estimation that the user 14 who is satisfied with the target event reproduces and displays a large number of the images 24 captured during the target event. It should be noted that the satisfaction level conversion table 90 is an example of a “condition related to an image-related evaluation value” according to the technology of the present disclosure.

As shown in a table 91, the derivation unit 57 calculates the number of times of reproduction of the image 24 captured during the target event for each user 14. For example, the derivation unit 57 calculates a value obtained by rounding off the arithmetic mean of the number of times that the user 14 reproduces and displays the image 24 on the user terminal 11 or the like during 3 months from the target event, as the number of times of reproduction of the image 24 captured during the target event. In a case in which the number of the images 24 captured during the target event is 3, the number of times of reproduction of the first image is 4, the number of times of reproduction of the second image is 6, and the number of times of reproduction of the third image is 3, an arithmetic mean of the number of times of reproduction is (4+6+3)/3≈4.3, so that the number of times of reproduction of the image 24 captured during the target event is 4.

As shown in a table 92, the derivation unit 57 converts the calculated number of times of reproduction into the satisfaction level by using the satisfaction level conversion table 90. Subsequent processing is the same as in the aspect in which the number of the captured images is adopted as the image-related evaluation value, and thus the description thereof will be omitted.

As described above, in the present aspect, the satisfaction level is derived based on the satisfaction level conversion table 90, which is a condition related to the number of times of reproduction of the image 24. Therefore, the satisfaction level can be derived by relatively simple processing, as in the aspect in which the number of the captured images is adopted as the image-related evaluation value.

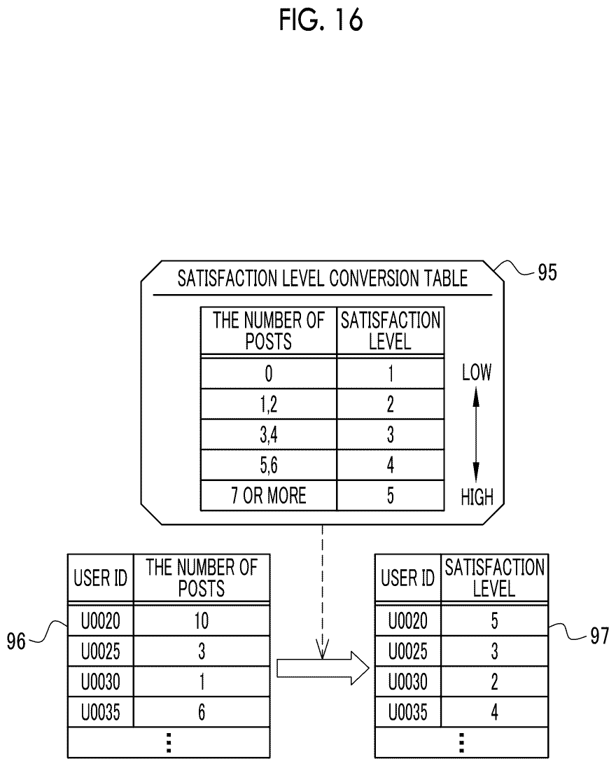

In addition, as shown in FIG. 16 as an example, the number of posts of the image 24 captured during the target event may be adopted as the image-related evaluation value. The number of posts of the image 24 is the number of the images 24 that are disclosed by the user 14 to an unspecified number of third parties through an image posting social networking service (SNS) or the like. In this case, the information processing server 10 receives the number of the images 24 posted by the user 14 to the image posting SNS or the like among the images 24 captured during the target event from a device, such as the user terminal 11, having a function of posting the image 24 to the image posting SNS or the like.

The derivation unit 57 uses a satisfaction level conversion table 95 in which the satisfaction level with the number of posts of the image 24 captured during the target event is registered. In FIG. 16, a satisfaction level 1 for the number of posts of 0, a satisfaction level 2 for the number of posts of 1 and 2, . . . , a satisfaction level 4 for the number of posts of 5 and 6, and a satisfaction level 5 for the number of posts of 7 or more are registered, respectively. The setting of the satisfaction level higher as the number of posts is larger in this way is based on the estimation that the user 14 who is satisfied with the target event posts a large number of the images 24 captured during the target event to the image posting SNS or the like. It should be noted that the satisfaction level conversion table 95 is an example of a “condition related to an image-related evaluation value” according to the technology of the present disclosure.

As shown in a table 96, the derivation unit 57 totals the number of posts of the image 24 captured during the target event for each user 14. For example, the derivation unit 57 totals the number of the images 24 posted by the user 14 to the image posting SNS or the like by using the user terminal 11 or the like during one week from the target event.

As shown in a table 97, the derivation unit 57 converts the totaled number of posts into the satisfaction level by using the satisfaction level conversion table 95. Subsequent processing is the same as in the aspect in which the number of the captured images is adopted as the image-related evaluation value, and thus the description thereof will be omitted.

As described above, in the present aspect, the satisfaction level is derived based on the satisfaction level conversion table 95, which is a condition related to the number of posts of the image 24. Therefore, the satisfaction level can be derived by relatively simple processing, as in the aspect or the like in which the number of the captured images is adopted as the image-related evaluation value.

The satisfaction level may be derived based on a condition related to at least two of the number of the captured images 24, the number of times of reproduction, and the number of posts of the number of the captured images 24 and the number of times of reproduction, the number of times of reproduction of the image 24 and the number of posts, or the number of the captured images 24, the number of times of reproduction, and the number of posts. In a case in which the number of the captured images 24 and the number of times of reproduction are used, for example, a total of the number of the captured images 24 and the number of times of reproduction is calculated, and the total is converted into the satisfaction level by using a satisfaction level conversion table in which the satisfaction level with the total is registered.

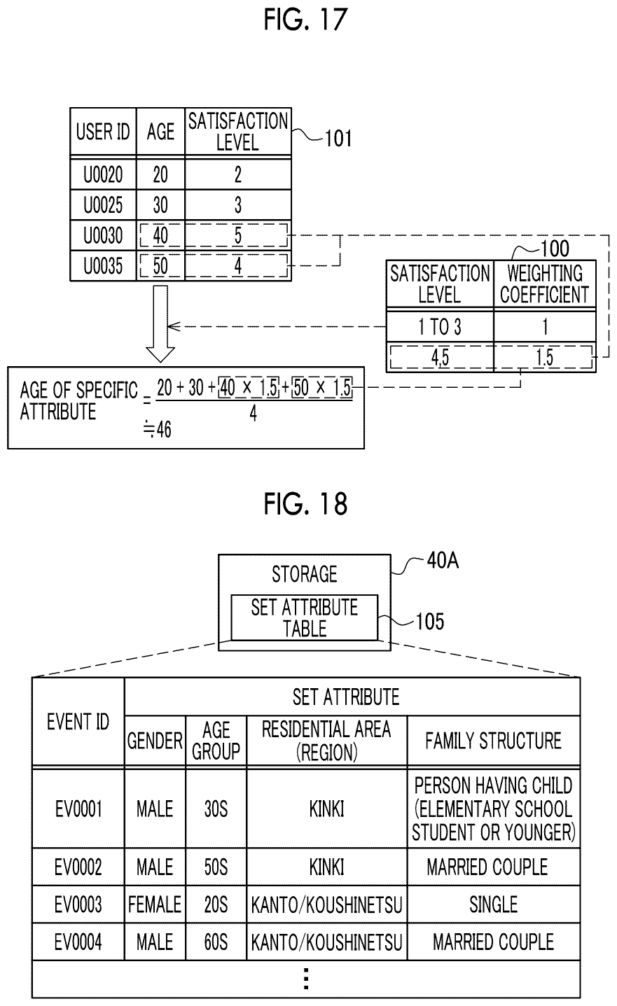

It should be noted that, as shown in FIG. 17 as an example, the satisfaction level may be taken into consideration in a case of deriving the specific attribute. In FIG. 17, the derivation unit 57 uses a weighting coefficient table 100 in a case of calculating the age of the specific attribute. The weighting coefficient table 100 is stored in the storage 40A.

First, as shown in a table 101, the derivation unit 57 derives the satisfaction level for each user 14. The derivation unit 57 obtains a weighted mean of the age of each user 14 by performing the addition by multiplying the age of each user 14 by a weighting coefficient according to the satisfaction level and dividing the obtained value by the number of users 14, and uses the obtained weighted mean as the age of the specific attribute.

FIG. 17 shows a case in which 1 is set as the weighting coefficient for the satisfaction levels 1 to 3 and 1.5 is set as the weighting coefficient for the satisfaction levels 4 and 5, respectively. In addition, FIG. 17 shows a case in which the weighting coefficient of 1.5 is multiplied by the age 40 of the user ID “U0030” having the satisfaction level 5 and the age 50 of the user ID “U0035” having the satisfaction level 4. In this case, the age of each user 14 is (20+30+40+50)/4=35 on a simple mean, but (20+30+40×1.5+50×1.5)/4≈46 according to the weighted mean.

As described above, in the present aspect, the derivation unit 57 performs heavier weighting in a case of deriving the specific attribute on the attribute of the user 14 having a higher satisfaction level. Therefore, it is possible to derive the specific attribute that is close to the attribute of the user 14 having a high satisfaction level.

The specific attribute may be derived by obtaining the weighted mean for the attributes other than age. For example, in a case of the gender, the weighted mean is calculated by substituting the gender with numerical values, such as 1 for the male and 2 for a female.

### 2_1st Embodiment

As shown in FIG. 18 as an example, in a 2_1st embodiment, a set attribute table 105 is stored in the storage 40A. A set attribute is registered in the set attribute table 105 for each event ID. The set attribute is, for example, an attribute of the user 14 set by the organizer 15 assuming that the user 14 is the main target of the event. Similar to the specific attribute, the set attribute includes items of the gender, the age group, the residential area (region), and the family structure of the user 14. It should be noted that the set attribute may be stored in the event information 22.

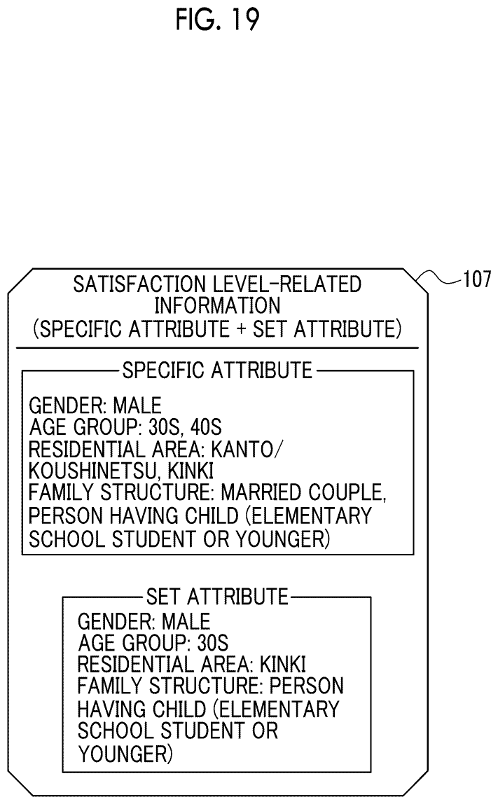

As shown in FIG. 19 as an example, the derivation unit 57 generates satisfaction level-related information 107 in which the set attribute is added to the specific attribute. FIG. 19 shows an example in which the male as the gender, 30s and 40s as the age group, Kanto/Koushinetsu and Kinki as the residential area, and the married couple and the person having the child (elementary school student or younger) as the family structure are derived as the specific attributes. In addition, FIG. 19 shows a case in which, as the set attribute, the gender is the male, the age group is 30s, the residential area is Kinki, and the family structure is the person having the child (elementary school student or younger).

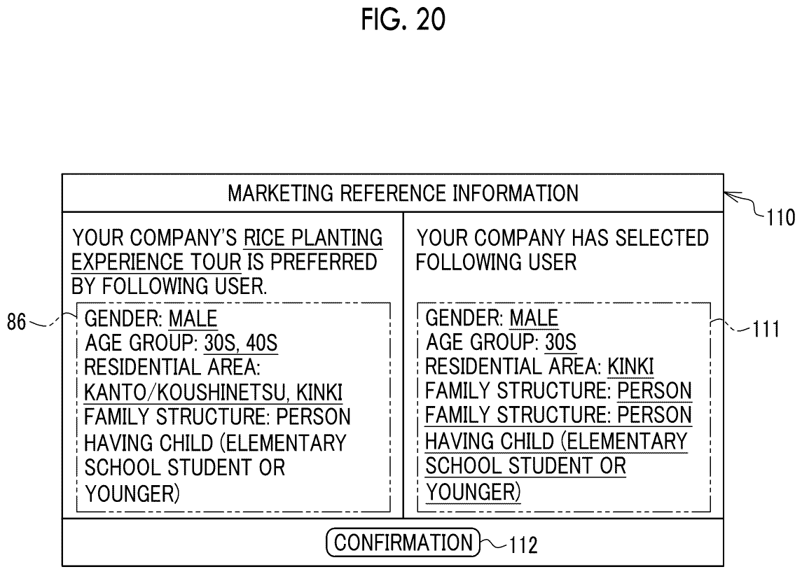

The browser control unit 80 of the organizer terminal 12 that receives the distribution of the satisfaction level-related information 107 displays and outputs an information display screen 110 shown in FIG. 20 to the display 44B, as an example. On the information display screen 110, in addition to the specific attribute indicated by the two-dot chain line enclosure and the reference numeral 86, the set attribute indicated by a two-dot chain line enclosure and a reference numeral 111 is displayed. In FIG. 20, a “rice planting experience tour” is shown as the target event. In addition, FIG. 20 shows the same example as in FIG. 19 as the specific attribute and the set attribute. The display of the information display screen 110 is turned off in a case in which a confirmation button 112 is selected.

As described above, in the 2_1st embodiment, the derivation unit 57 presents, in addition to the specific attribute, the set attribute, which is the attribute of the user 14 set by the organizer 15 in the target event, as the satisfaction level-related information 107. Therefore, as shown in the information display screen 110 shown in FIG. 20, the organizer 15 can compare the specific attribute with the set attribute. In a case in which the specific attribute and the set attribute are substantially the same as in the present example, the organizer 15 can confirm that the setting of the organizer 15 is correct. On the contrary, in a case in which the specific attribute and the set attribute are different from each other, the organizer 15 can reexamine the set attribute. As a result, it is possible to take effective measures for increasing the number of the users 14 who participate in the target event.

### 2_2nd Embodiment

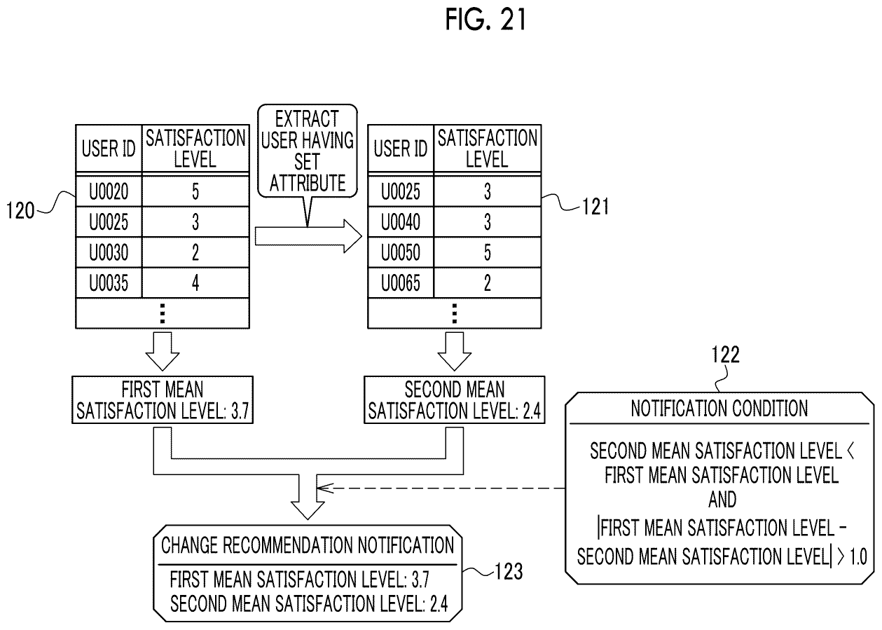

In a 2_2nd embodiment, the set attribute table 105 is stored in the storage 40A as in the 2_1st embodiment described above. Then, as shown in FIG. 21 as an example, the derivation unit 57 derives the satisfaction levels of all the users 14 who participate in the target event, as shown in a table 120. In addition, as shown in a table 121, the derivation unit 57 extracts the user 14 having the set attribute set in the target event by the organizer 15 from among the users 14 who participate in the target event, and also extracts the satisfaction level thereof. Specifically, the user 14 having the set attribute is the user 14 of which the gender, the age group, the residential area, and the family structure all match the set attributes. It should be noted that the set attribute is, for example, the attribute of the user 14 set by the organizer 15 assuming that the user 14 is the main target of the event, as in the 2_1st embodiment described above.

The derivation unit 57 calculates a first mean satisfaction level, which is a mean value of the satisfaction levels of all the users 14 who participate in the target event. In addition, the derivation unit 57 calculates a second mean satisfaction level, which is a mean value of the satisfaction levels of the users 14 having the set attributes. The first mean satisfaction level is an example of a “first representative satisfaction level” according to the technology of the present disclosure. In addition, the second mean satisfaction level is an example of a “second representative satisfaction level” according to the technology of the present disclosure. It should be noted that a most frequent value of the satisfaction levels of all the users 14 who participate in the target event may be set as the first representative satisfaction level. Similarly, a most frequent value of the satisfaction levels of the users 14 having the set attributes may be set as the second representative satisfaction level.

In a case in which the first mean satisfaction level and the second mean satisfaction level satisfy a notification condition 122 set in advance, the distribution control unit 58 distributes a change recommendation notification 123 to the organizer terminal 12 of the organizer 15 of the target event. The notification condition 122 is a content that the second mean satisfaction level is lower than the first mean satisfaction level (second mean satisfaction level<first mean satisfaction level), and an absolute value of a difference between the first mean satisfaction level and the second mean satisfaction level is larger than 1.0, which is a threshold value set in advance (|first mean satisfaction level−second mean satisfaction level|>1.0). The change recommendation notification 123 is a notification prompting the user to change the set attribute, and includes the first mean satisfaction level and the second mean satisfaction level. FIG. 21 shows a case in which the first mean satisfaction level is 3.7, the second mean satisfaction level is 2.4, and the notification condition 122 is satisfied. It should be noted that |first mean satisfaction level−second mean satisfaction level|>1.0 is an example of a “threshold value condition” according to the technology of the present disclosure.

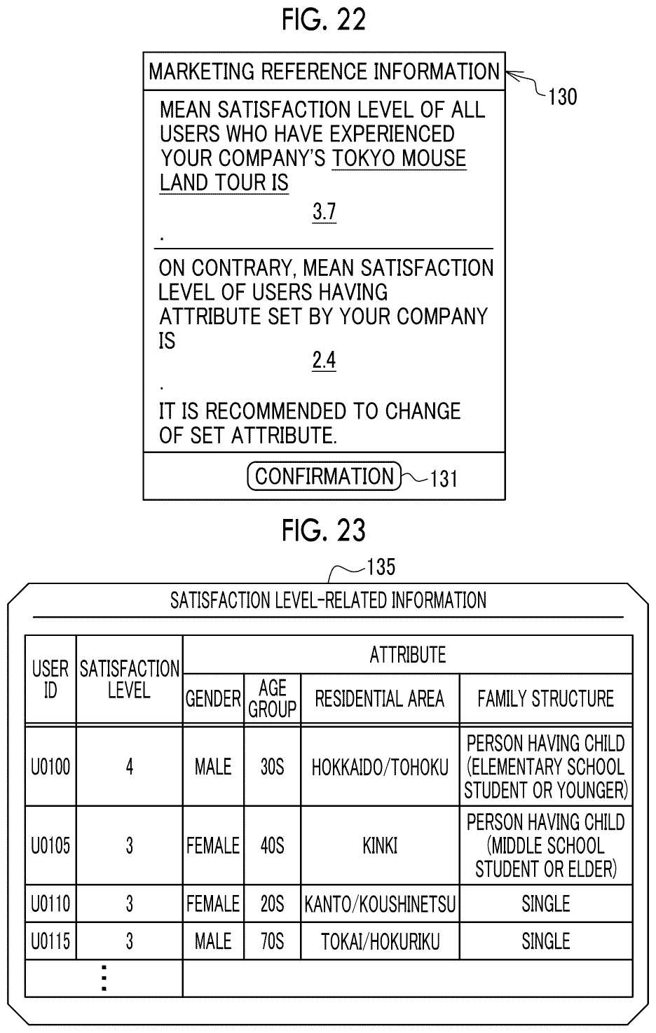

The browser control unit 80 of the organizer terminal 12 that receives the distribution of the change recommendation notification 123 displays and outputs an information display screen 130 shown in FIG. 22 to the display 44B, as an example. The information display screen 130 displays the name of the target event, the first mean satisfaction level, and the second mean satisfaction level. In addition, a message prompting the organizer 15 to change the set attribute is displayed on the information display screen 130. The display of the information display screen 130 is turned off in a case in which a confirmation button 131 is selected.

As described above, in the 2_2nd embodiment, the derivation unit 57 derives the first mean satisfaction level as the first representative satisfaction level representing the satisfaction levels of all the users 14 who participate in the target event. In addition, the derivation unit 57 derives the second mean satisfaction level as the second representative satisfaction level representing the satisfaction level of the user 14 having the set attribute set in the target event by the organizer 15 among the users 14 who participate in the target event. In a case in which the second mean satisfaction level is lower than the first mean satisfaction level, and the absolute value of the difference between the first mean satisfaction level and the second mean satisfaction level satisfies the threshold value condition set in advance, the distribution control unit 58 presents the change recommendation notification 123 prompting to change the set attribute to the organizer 15.

A case in which the second mean satisfaction level is lower than the first mean satisfaction level and the absolute value of the difference between the first mean satisfaction level and the second mean satisfaction level satisfies the threshold value condition set in advance is a case in which there is a large deviation between the set attribute set by the organizer 15 and the attribute of the user 14 who actually participates in the target event. For this reason, by strongly prompting the organizer 15 to reexamine the set attribute that is significantly deviated from the actual situation by the change recommendation notification 123, it is possible to create an opportunity to significantly change the policy of the marketing strategy of the organizer 15 to increase the number of the users 14 who participate in the target event.

The set attribute need only be the attribute of the user 14 set by the organizer 15, and is not limited to the attribute of the user 14 assumed by the organizer 15 as the main target of the event as shown as an example.

It should be noted that the satisfaction level-related information is not limited to the specific attribute, or the specific attribute and the set attribute. As shown in FIG. 23 as an example, information in which the satisfaction level and the attribute of the user 14 are associated with each other may be presented as the satisfaction level-related information 135. In this case, the derivation of the specific attribute and the like need only be performed on the organizer terminal 12 that receives the distribution of the satisfaction level-related information 135. In this case, it is not necessary to derive the specific attribute or the like, so that a processing load of the information processing server 10 can be reduced.

A configuration may be adopted in which it is possible to select whether to distribute the satisfaction level-related information 26 of the specific attribute, the satisfaction level-related information 107 of the specific attribute and the set attribute, or the satisfaction level-related information 135 in which the satisfaction level and the attribute of the user 14 are associated with each other.

### Third Embodiment

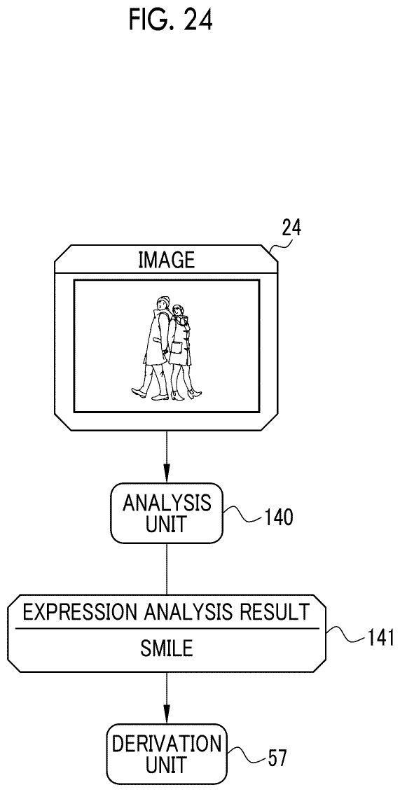

As an example, as shown in FIG. 24, the CPU 42A of the information processing server 10 according to a third embodiment functions as an analysis unit 140, in addition to the request reception unit 55, the acquisition unit 56, the derivation unit 57, and the distribution control unit 58 according to the first embodiment described above. The analysis unit 140 analyzes whether or not an expression of a face is a smile on the image 24 in which the face of the person appears. The analysis unit 140 outputs an expression analysis result 141, which is an analysis result, to the derivation unit 57. FIG. 24 shows a case in which it is analyzed that the expression of the face is the smile.

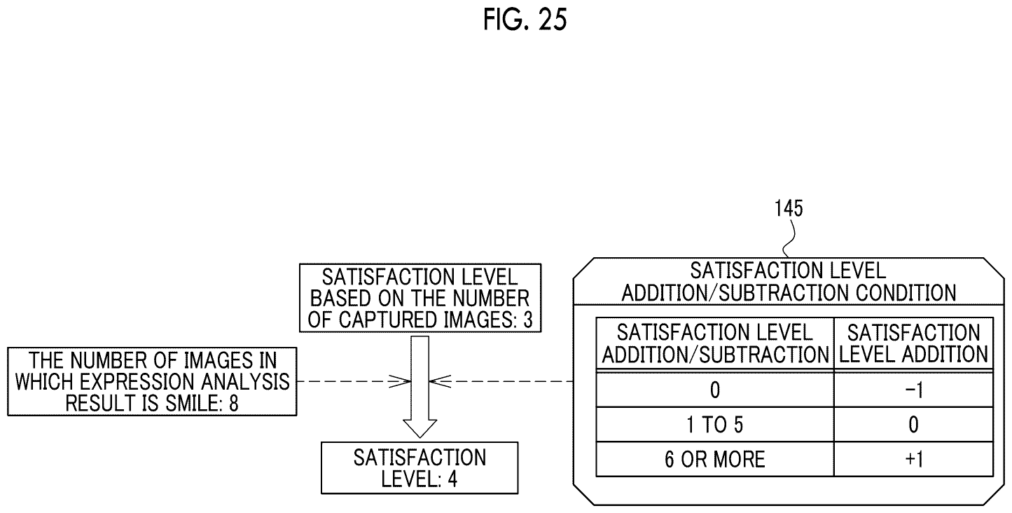

As shown in FIG. 25 as an example, the derivation unit 57 derives the satisfaction level based on the number of the captured images 24 as in the first embodiment described above. In addition, the derivation unit 57 counts the number of the images 24 in which the expression analysis result 141 is the smile among the images 24 captured during the target event for each user 14. Then, the satisfaction level derived from the number of the captured images 24 is added or subtracted based on the number of the images 24 in which the expression analysis result 141 is the smile, and a satisfaction level addition/subtraction condition 145 set in advance.

The satisfaction level addition/subtraction condition 145 is stored in the storage 40A. For example, the satisfaction level addition/subtraction condition 145 is that 1 is subtracted from the satisfaction level in a case in which the number of the images 24 in which the expression analysis result 141 is the smile is 0. Moreover, for example, the satisfaction level addition/subtraction condition 145 is that the satisfaction level is not added or subtracted in a case in which the number of the images 24 in which the expression analysis result 141 is the smile is 1 to 5. Further, the satisfaction level addition/subtraction condition 145 is that 1 is added to the satisfaction level in a case in which the number of the images 24 in which the expression analysis result 141 is the smile is 6 or more.

FIG. 25 shows a case in which the number of the images 24 in which the expression analysis result 141 is the smile is 8, and the satisfaction level derived based on the number of the captured images 24 is 3. In this case, since the number of the images 24 in which the expression analysis result 141 is the smile is 6 or more, the derivation unit 57 adds 1 to 3 of the satisfaction level derived based on the number of the captured images 24 to obtain 4 as the satisfaction level.

In a case in which the satisfaction level derived based on the number of the captured images 24 is the lowest 1 and the number of the images 24 in which the expression analysis result 141 is the smile is 0, 1 is not subtracted from the satisfaction level, and the satisfaction level is 1 as it is. In addition, in a case in which the satisfaction level derived based on the number of the captured images 24 is the highest 5 and the number of the images 24 in which the expression analysis result 141 is the smile is 6 or more, 1 is not added to the satisfaction level, and the satisfaction level is 5 as it is. Of course, 1 may be subtracted from the satisfaction level to obtain 0 in the former case, or 1 may be added to the satisfaction level to obtain 6 in the latter case.

As described above, in the third embodiment, the derivation unit 57 derives the satisfaction level based on the expression analysis result 141, which is the analysis result of the expression of the person appearing in the image 24. Since the satisfaction level is derived from the expression of the person who clearly indicates whether or not he/she is enjoying the target event, the reliability of the satisfaction level can be further improved.

It should be noted that, FIG. 25 shows the satisfaction level derived from the number of the captured images 24 is added or subtracted based on the number of the images 24 in which the expression analysis result 141 is the smile, and the satisfaction level addition/subtraction condition 145 set in advance. However, the present disclosure is not limited to this. The satisfaction level derived from the number of times of reproduction of the image 24 shown in FIG. 15 or the satisfaction level derived from the number of posts of the image 24 shown in FIG. 16 may be added or subtracted. In addition, the number of the images 24 in which the expression analysis result 141 is the smile may be directly converted into the satisfaction level by using a satisfaction level conversion table in which the satisfaction level corresponding to the number of the images 24 in which the expression analysis result 141 is the smile is registered.

### 4_1st Embodiment

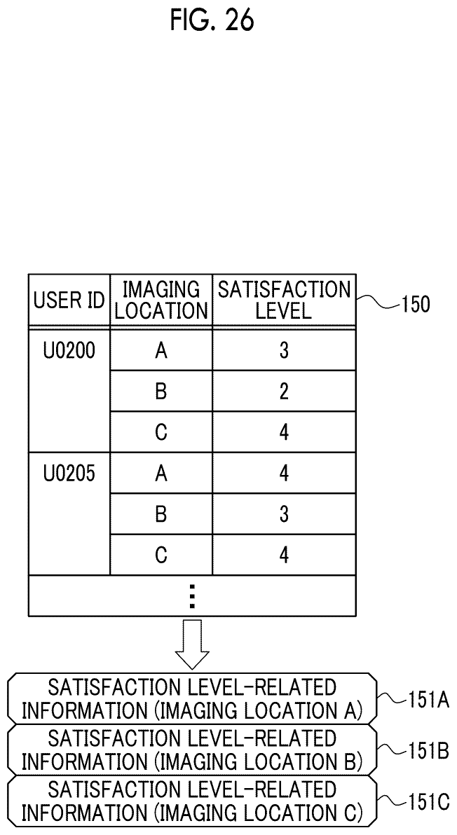

As an example, as shown in a table 150 of FIG. 26, in a 4_1st embodiment, the derivation unit 57 derives the satisfaction level for each user 14 for each imaging location of the image 24 in the target event. The derivation unit 57 generates satisfaction level-related information 151 for each imaging location. As described above, the imaging location is known from the longitude and latitude information obtained by the GPS function built in the user terminal 11 or the digital camera that captures the image 24. The imaging location for which the satisfaction level is derived is set in advance by the organizer 15.

The derivation unit 57 obtains the image-related evaluation value, such as the number of the captured images for each imaging location as preprocessing of deriving the satisfaction level for each imaging location. Then, the obtained image-related evaluation value is converted into the satisfaction level by using the satisfaction level conversion table. It should be noted that the satisfaction level-related information 151 may be only the specific attribute, may be the specific attribute and the set attribute, or may be the information in which the satisfaction level and the attribute of the user 14 are associated with each other.

FIG. 26 shows an example in which the satisfaction levels of three imaging locations A, B, and C are derived. In addition, FIG. 26 shows an example in which satisfaction level-related information 151A of the imaging location A, satisfaction level-related information 151B of the imaging location B, and satisfaction level-related information 151C of the imaging location C are generated.

As described above, in the 4_1st embodiment, the satisfaction level is derived for each imaging location of the image 24 in the target event. Therefore, the satisfaction level-related information 151 for each imaging location can be generated. The organizer 15 can know what is an attribute of the user 14 who has a high satisfaction level for each imaging location by using the satisfaction level-related information 151 for each imaging location. For example, in a case in which the target event is the tour to play at a theme park and the imaging location is an attraction in the theme park, it is possible to know which attraction is popular with which user 14.

### 4_2nd Embodiment

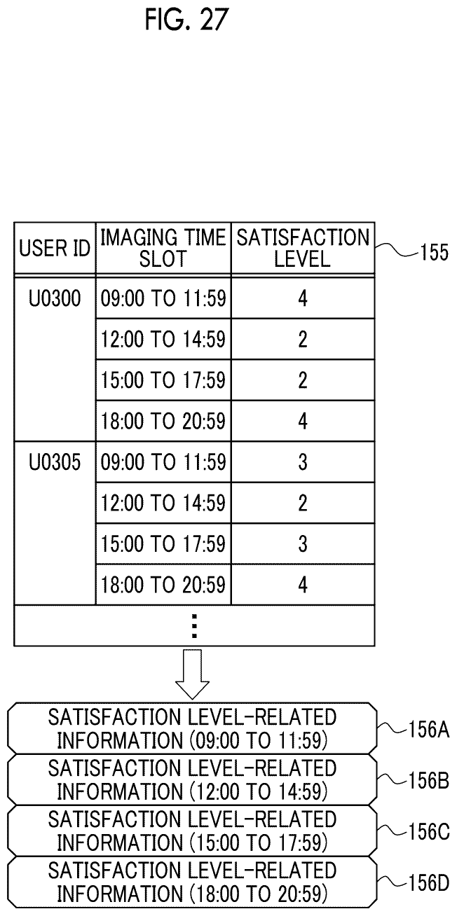

As an example, as shown in a table 155 of FIG. 27, in a 4_2nd embodiment, the derivation unit 57 derives the satisfaction level for each user 14 for each imaging time slot of the image 24 in the target event. The derivation unit 57 generates satisfaction level-related information 156 for each imaging time slot. As described above, the imaging time slot is known from the imaging date and time of the accessory information 36 of the image 24. The imaging time slot for which the satisfaction level is derived is set in advance by the organizer 15.

As in the 4_1st embodiment described above, the derivation unit 57 obtains the image-related evaluation value, such as the number of the captured images for each imaging time slot as preprocessing of deriving the satisfaction level for each imaging time slot. Then, the obtained image-related evaluation value is converted into the satisfaction level by using the satisfaction level conversion table. It should be noted that, similar to the satisfaction level-related information 151 according to the 4_1st embodiment described above, the satisfaction level-related information 156 may be only the specific attribute, may be the specific attribute and the set attribute, or may be the information in which the satisfaction level and the attribute of the user 14 are associated with each other.

FIG. 27 shows an example in which the satisfaction levels of four imaging time slots of 09:00 to 11:59, 12:00 to 14:59, 15:00 to 17:59, and 18:00 to 20:59 are derived. In addition, FIG. 27 shows an example in which satisfaction level-related information 156A of 09:00 to 11:59, satisfaction level-related information 156B of 12:00 to 14:59, satisfaction level-related information 156C of 15:00 to 17:59, and satisfaction level-related information 156D of 18:00 to 20:59 are generated.

As described above, in the 4_2nd embodiment, the satisfaction level is derived for each imaging time slot of the image 24 in the target event. Therefore, the satisfaction level-related information 156 for each imaging time slot can be generated. The organizer 15 can know what is an attribute of the user 14 who has a high satisfaction level for each imaging time slot by using the satisfaction level-related information 156 for each imaging time slot. For example, in a case in which the target event is a music festival in which a plurality of artists appear and the imaging by the user (viewer of the event) is permitted, it is possible to know which time slot (which artist) is popular with which user 14.

The 4_1st embodiment and the 4_2nd embodiment may be carried out in combination. Specifically, the satisfaction level may be derived for each imaging location of the image 24 in the target event and for each imaging time slot.

The attribute of the user 14 and a table 66 or the like in which the satisfaction level is registered for each user ID may be distributed to the organizer terminal 12. In this case, the browser control unit 80 of the organizer terminal 12 may display and output, for example, an information display screen including a histogram having the number of persons as a vertical axis and the satisfaction level as a horizontal axis for the user 14 who is the male on the display 44B.

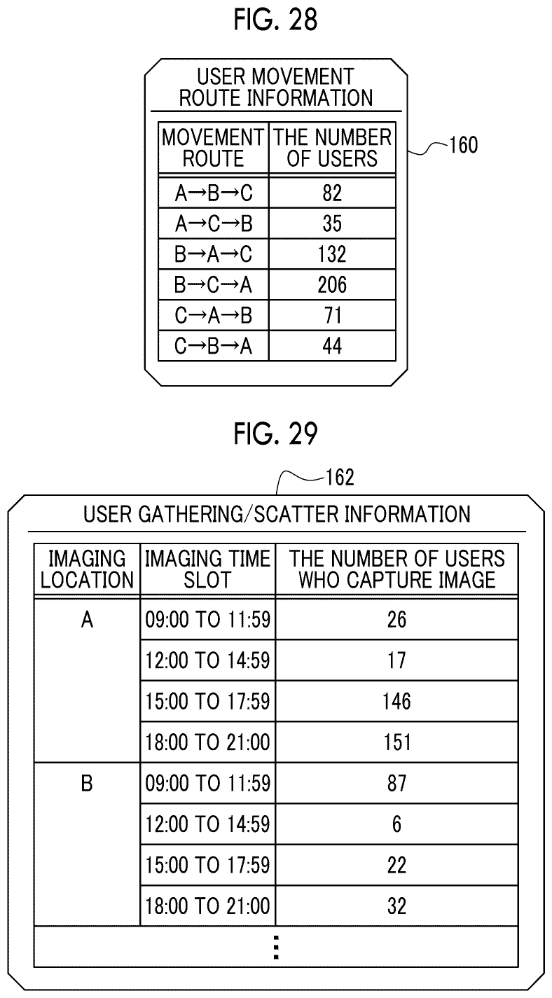

As an example, as shown in FIG. 28, the information processing server 10 may generate user movement route information 160 in which the number of the users 14 who actually follow each movement route is totaled for each movement route of each location of the target event, and may distribute the generated user movement route information 160 to the organizer terminal 12. Which movement route the user 14 follows is known from the imaging location and the imaging date and time of the image 24. FIG. 28 shows an example in which the number of the users 14 is totaled for each of 6 movement routes that follow three locations A, B, and C of the target event, such as A→B→C, B→A→C, and C→A→B.

According to the user movement route information 160, it is possible for the organizer 15 to know which movement route is followed by how many users 14. For this reason, it is possible for the organizer 15 to perform the management according to the movement route of the user 14 by installing a restaurant, a souvenir shop, or the like in the middle of the movement route followed by many users 14, installing a new attraction in the movement route that is not often followed by the user 14 to scatter the flow of the users 14, or the like.

In addition, as shown in FIG. 29 as an example, the information processing server 10 may generate user gathering/scatter information 162 in which the number of the users 14 who capture the image 24 is totaled for each imaging location and each imaging time slot of the image 24 in the target event, and may distribute the generated user gathering/scatter information 162 to the organizer terminal 12.

According to the user gathering/scatter information 162, it is possible for the organizer 15 to know at what location, in what time slot, how many users 14 are gathered. For this reason, it is possible for the organizer 15 to perform the management according to a gathering/scatter situation of the users 14 by increasing the number of guards in the time slot in which many users 14 are gathered, opening a wagon that sells light meals in the time slot in which many users 14 are gathered, or the like for each location.

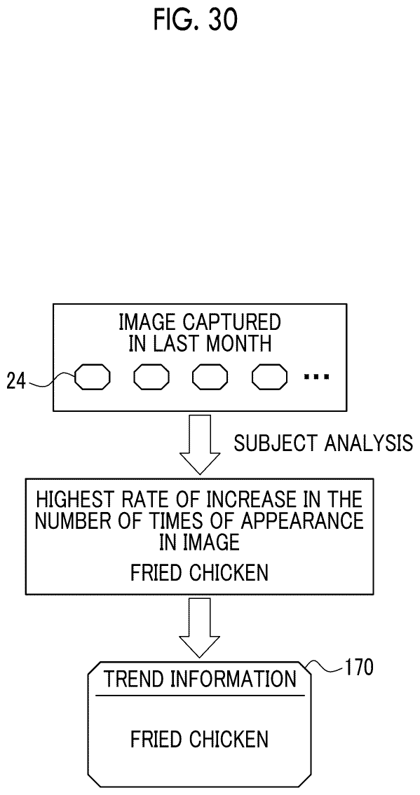

As shown in FIG. 30 as an example, the information processing server 10 may analyze a subject in the image 24 captured in the last 1 month, for example, among the images 24 accumulated in the image DB 25, and may distribute the highest rate of increase from 1 month before in the number of times the subject appears in the image 24 as trend information 170 to the organizer terminal 12. FIG. 30 shows a case in which the subject having the highest rate of increase from 1 month before in the number of times the subject appears in the image 24 is a fried chicken.

According to the trend information 170, it is possible for the organizer 15 to know what is currently trending. Therefore, it is possible for the organizer 15 to perform the management according to the trend, such as selling a product related to the trend information 170 in the event or the like.

It should be noted that the image 24, which is a source of the derivation of the trend information 170, may be narrowed down to the image 24 captured by the user 14 having a limited attribute, for example, a female in 20s. The image 24 may be narrowed down to the image 24 captured by the user 14 having the set attribute.

The satisfaction level-related information has a low value as information unless the number of the users 14 who participate in the target event is gathered to some extent. Therefore, it is preferable to suppress the distribution of the satisfaction level-related information until the number of the users 14 who participate in the target event is equal to or more than a threshold value set in advance.

The form of presenting the satisfaction level-related information to the organizer 15 of the target event is not limited to the form of distributing the satisfaction level-related information to the organizer terminal 12 as shown as an example. A form of printing out the satisfaction level-related information on a paper medium and mailing the printed satisfaction level-related information to the organizer 15 of the target event may be used, or a form of attaching the satisfaction level-related information to an e-mail and transmitting the attached satisfaction level-related information to the organizer 15 of the target event may be used.

A hobby, a taste, a personality, and the like may be added to the attribute of the user 14. The image-related evaluation value, such as the number of the captured images, may be used as it is as the satisfaction level. The management entity of the information processing server and the image DB server 21 and the management entity of the event information DB server may be the same as or different from each other.

The method of applying for the event is not limited to the method of searching for and applying for the event information 22 of the event desired by the user 14 as shown as an example. The information processing server 10 may distribute the recommended event information 22 based on the set attribute to the user terminal 11, and the user 14 may apply for the event of the recommended event information 22.

The information processing server 10 may be responsible for some of the functions of the browser control unit 80 of the organizer terminal 12. Specifically, various screens, such as the information display screen 85, are generated in the information processing server 10, and are distributed and output to the organizer terminal 12 in a format of screen data for web distribution created by a markup language such as extensible markup language (XML). In this case, the browser control unit 80 of the organizer terminal 12 represents various screens to be displayed on the web browser based on the screen data and displays various screens on the display 44B. It should be noted that another data description language, such as Javascript (registered trademark) object notation (JSON), may be used instead of the XML.

The user terminal 11 that transmits the image 24 to the information processing server and the user terminal 11 that receives the distribution of the event information 22 from the information processing server 10 may be separate from each other. For example, in a case in which there are a plurality of user terminals 11 having the account of the same user 14, the image 24 may be transmitted from one user terminal 11 to the information processing server and the event information 22 may be distributed from the other information processing server 10 to the other user terminal 11.

It is possible to modify a hardware configuration of the computer constituting the information processing server 10 in various ways. For example, the information processing server 10 can be configured by using a plurality of computers separated as hardware for the purpose of improving processing ability and reliability. For example, two computers are responsible for the functions of the request reception unit 55 and the acquisition unit 56, and the functions of the derivation unit 57 and the distribution control unit 58 in a distributed manner. In this case, the information processing server 10 is configured by using two computers. Also, the information processing server 10, the event information DB server 20, and the image DB server 21 may be integrated into one server.

As described above, the hardware configuration of the computer of the information processing server 10 can be appropriately changed according to the required performance, such as the processing ability, the safety, and the reliability. Further, it is also needless to say that, in addition to the hardware, the APs, such as the operation program 50 and the marketing AP 75, can also be duplicated or distributed and stored in a plurality of storages for the purpose of securing the safety and the reliability.

In each of the embodiments described above, for example, as a hardware structure of processing units that execute various types of processing, such as the request reception unit 55, the acquisition unit 56, the derivation unit 57, the distribution control unit 58, the browser control unit 80, and the analysis unit 140, the various processors described below can be used. The various processors include, for example, the CPUs 42A and 42B which are general-purpose processors executing software (operation program 50 and marketing AP 75) to function as various processing units, a programmable logic device (PLD), such as a field programmable gate array (FPGA), which is a processor whose circuit configuration can be changed after manufacture, and/or a dedicated electric circuit, such as an application specific integrated circuit (ASIC), which is a processor having a dedicated circuit configuration designed to execute specific processing.

One processing unit may be configured by using one of these various processors, or may be configured by using a combination of two or more processors of the same type or different types (for example, a combination of a plurality of FPGAs and/or a combination of a CPU and an FPGA). In addition, a plurality of the processing units may be configured by using one processor.

As an example in which the plurality of processing units are configured by using one processor, first, as represented by a computer such as a client and a server, there is a form in which one processor is configured by using a combination of one or more CPUs and software and this processor functions as the plurality of processing units. Second, as represented by a system on chip (SoC) or the like, there is a form in which a processor that realizes the functions of the entire system including the plurality of processing units with one integrated circuit (IC) chip is used. In this way, as the hardware structure, the various processing units are configured by using one or more of the various processors described above.

Further, more specifically, an electric circuit (circuitry) in which circuit elements, such as semiconductor elements, are combined can be used as the hardware structure of the various processors.

In the technology of the present disclosure, the above-described various embodiments and/or various modification examples can be appropriately combined. Further, it is needless to say that the present disclosure is not limited to each of the above-described embodiments and various configurations can be adopted without departing from the scope of the technology of the present disclosure. Further, the technology of the present disclosure extends to a storage medium that non-transitorily stores a program in addition to the program.

The contents described and shown above are detailed descriptions of portions according to the technology of the present disclosure and are merely examples of the technology of the present disclosure. For example, the above description of the configurations, functions, actions, and effects is a description of an example of the configurations, functions, actions, and effects of the portions according to the technology of the present disclosure. Accordingly, it goes without saying that unnecessary portions may be deleted, new elements may be added, or replacement may be made with respect to the contents described and shown above without departing from the scope of the technology of the present disclosure. In addition, in order to avoid complication and facilitate understanding of portions according to the technology of the present disclosure, description related to common technical knowledge or the like that does not need to be particularly described for enabling implementation of the technology of the present disclosure is omitted in the contents described and shown above.

In the present specification, “A and/or B” has the same meaning as “at least one of A or B”. That is, “A and/or B” means that only A may be used, only B may be used, or a combination of A and B may be used. In addition, in the present specification, in a case in which three or more matters are expressed by being connected by “and/or”, the same concept as “A and/or B” is applied.

All documents, patent applications, and technical standards described in the present specification are incorporated in the present specification by reference to the same extent as a case in which each individual publication, patent application, or technical standard is specifically and individually indicated to be incorporated by reference.

What is claimed is:

1. An information processing apparatus comprising:
a processor; and
a memory connected to or built in the processor,
wherein the processor
acquires an image captured by a user during a target event for which a satisfaction level of the user is measured,
derives the satisfaction level of the user with the target event based on the image, and
presents an attribute of the user and satisfaction level-related information which is related to the satisfaction level to an organizer of the target event.

2. The information processing apparatus according to claim 1,
wherein the processor
derives a specific attribute, which is an attribute of a user who tends to prefer the target event among the users who participate in the target event, by statistically analyzing the satisfaction level, and
presents the specific attribute as the satisfaction level-related information.

3. The information processing apparatus according to claim 2,
wherein the processor performs heavier weighting in a case of deriving the specific attribute on an attribute of the user having a higher satisfaction level.

4. The information processing apparatus according to claim 2,
wherein the processor presents, in addition to the specific attribute, a set attribute, which is an attribute of the user set by the organizer in the target event, as the satisfaction level-related information.

5. The information processing apparatus according to claim 1,
wherein the processor
derives a first representative satisfaction level, which represents the satisfaction levels of all the users who participate in the target event, and a second representative satisfaction level, which represents the satisfaction level of a user having a set attribute set by the organizer in the target event among the users who participate in the target event, and
presents a notification prompting to change the set attribute to the organizer in a case in which the second representative satisfaction level is lower than the first representative satisfaction level, and an absolute value of a difference between the first representative satisfaction level and the second representative satisfaction level satisfies a threshold value condition set in advance.

6. The information processing apparatus according to claim 1,
wherein the processor presents information in which the satisfaction level and the attribute of the user are associated with each other, as the satisfaction level-related information.

7. The information processing apparatus according to claim 1,
wherein the processor derives the satisfaction level based on a condition related to an image-related evaluation value, which is at least any one of the number of the captured images, the number of times of reproduction of the image, or the number of posts of the image.

8. The information processing apparatus according to claim 1,
wherein the processor derives the satisfaction level based on an analysis result of an expression of a person appearing in the image.

9. The information processing apparatus according to claim 1,
wherein the processor derives the satisfaction level for at least any one of an imaging location or an imaging time slot of the image in the target event.

10. An operation method of an information processing apparatus, the method comprising:
acquiring an image captured by a user during a target event for which a satisfaction level of the user is measured;
deriving the satisfaction level of the user with the target event based on the image; and
presenting an attribute of the user and satisfaction level-related information which is related to the satisfaction level to an organizer of the target event.

11. A non-transitory computer-readable storage medium storing an operation program of an information processing apparatus, the program causing a computer to execute a process comprising:
acquiring an image captured by a user during a target event for which a satisfaction level of the user is measured;
deriving the satisfaction level of the user with the target event based on the image; and
presenting an attribute of the user and satisfaction level-related information which is related to the satisfaction level to an organizer of the target event.
